(19) United States
(12) Patent Application Publication
(10) Pub. No.: US 2005/0244550 A1
(43) Pub. Date: Nov. 3, 2005

(54) Disposable condiment tray holder and method

(76) Inventors: Suzanne Penfold, Pittsford, NY (US); Craig McGrain, Pittsford, NY (US); Craig N. Wilson, Pittsford, NY (US)

Correspondence Address: Thomas R. FitzGerald, Esq., Suite 210, 16 E. Main Street, Rochester, NY, 14614-1808, US

(21) Appl. No.: 11/083,051

(22) Filed: Mar. 17, 2005

Related U.S. Application Data
(60) Provisional application No. 60/554,144, filed on Mar. 18, 2004.

(51) Int. Cl. A23B 4/00

(52) U.S. Cl. 426/115

(57) ABSTRACT

A serving unit 10 holds disposable serving trays made of thin walled thermoformed material. The serving trays are one-time-useable to hold condiments and prepared foods. The disposable trays are made in standard sizes to fit existing display units. The trays 30, 40 are made by thermoforming, injection molding or blow molding. It is possible to make thin gage parts formed from sheet thickness of 100 to 1 mils. Materials for the trays include APT, HDPS, PP, PE, OPS, and HIPS.

### CROSS-REFERENCE TO RELATED APPLICATIONS

This application claims the benefit of the priority date of U.S. Provisional Patent Application Ser. No. 60/554,144 filed Mar. 18, 2004.

### FIELD

This invention relates in general to food preparation, storage and delivery and in particular to an apparatus and method for preparing, storing and delivering condiments and prepared foods in disposable trays for placement in standard display units.

### BACKGROUND

In food service establishments, such as restaurants, cafeterias, convenience stores and food carts, condiments such as relish, mustard, catsup, salsa, and prepared foods such as chopped onions, tomatoes, lettuce, olives, shredded cheese, ham chunks, chick peas, and other sandwich toppings and salad ingredients are often found in standard service trays. The trays are normally made from stainless steel or durable plastic. The trays are made in standard sizes that are conventionally referred to as full, half, one third, one quarter, one sixth and one ninth sizes. It is customary industry practice to supply the condiments and the prepared foods in large containers that typically hold several gallons of the condiments or foods. The establishment operator stores the containers in a refrigerator. At the start of each day or the prior night, the operator fills the service trays with fresh condiments and food and replenishes the trays with more supplies as required. At the end of the day the operator discards the unused condiments and foods and washes the trays to have them clean for the next day.

However, the existing delivery, storage and display systems have several drawbacks. When an operator relies upon the conventional method of receiving foodstuffs in large containers, there is the inevitable problem of cleaning the service trays. Such trays become encrusted with unused food or condiments. They must be serviced by employees who have to replenish and clean them. Many times the trays should be cleaned during the day before they are replenished, but that rarely occurs unless the employees are scrupulous about cleanliness. They must be cleaned at the end of the day, but, again, the degree of cleanliness will depend upon the diligence of the operator or his or her employees.

### SUMMARY

The problems and drawbacks of the prior art systems have created a need for a cleaner, less expensive and more reliable system for delivering, storing, serving and disposing of condiments and prepared foods. The invention addresses that need and provides an apparatus and method that is cleaner, less expensive and more reliable than the prior art. The invention relies upon the discovery that people are more inclined to dispose of light gauge trays than they are inclined to dispose of stainless steel or durable plastic trays. In particular, the invention relies on the discovery that very thin service trays may be pressure or vacuum thermoformed from plastic sheets. Alternate molding methods include injection and blow molding. The trays are so thin that most employees recognize it is useless to save or clean them. In addition, the thin trays are so low in cost that the operator of the establishment is encouraged to purchase large supplies of such one-time-useable, disposable service trays.

The invention provides an apparatus for holding an array of disposable serving trays containing condiments or prepared foods. The apparatus has a base with sidewalls that support a top surface. That surface has openings and each opening is sized to receive a standard size service tray. The openings have disposable condiment trays. The condiment trays are made of relatively thin gauge thermoformed; injection molded or blow molded plastic material.

Each tray has a rim and a bowl. The rim rests on the top surface of the display apparatus and the bowl is suspended inside the opening. The disposable tray is rigid enough to maintain a conventional serving tray shape when filled with condiments and is thin enough to have little or no perceived value for retention. This perception is enhanced by deliberately making the tray so thin as to have a flimsy appearance. For example, if the plastic is black, the tray is so thin that he lower corners may be translucent or even transparent. The lower corners are flexible to the touch. The service trays of the apparatus are formed from starting stock that is relatively thin, in the order of between 100 and 1 mils, with a preferred thickness of 30 mils for amorphous polyethylene terephthalate.

In another embodiment of the invention the operator purchases condiments in one-time-useable, disposable plastic trays. Such trays may be placed directly in the condiment stand. That method saves the operator the time and effort of filling trays and reduces the storage requirements. Since food deliveries are often made daily, the operator may reduce the size and cost of refrigeration equipment by purchasing only as much condiments and prepared foods as will be used between deliveries. Such a method is called just-in-time delivery and it gives the operator a consistent supply of fresh condiments and freshly prepared foods in clean service trays.

The trays are pre-filled with condiments and food, sealed with a film lid, and delivered to the food establishment. The film lids on the trays are opened or removed and the trays are inserted into the holding apparatus for use by staff or customers. When the trays are empty, a new tray is inserted into the holding apparatus and the used tray is discarded. In the alternative, condiments and prepared food may still be taken from larger containers and served in the service trays. In either case, instead of cleaning the service trays, they are disposed of after one use.

### DRAWINGS

FIG. 1 is a perspective view of a serving unit for holding one-time useable service trays.

FIG. 2 is a plan view of the serving unit of FIG. 1,

FIGS. 3a-3c show plan, first and second side views of a one sixth size service tray.

FIGS. 3d-3f plan, first and second side views of a one ninth size service tray.

### DETAILED DESCRIPTION

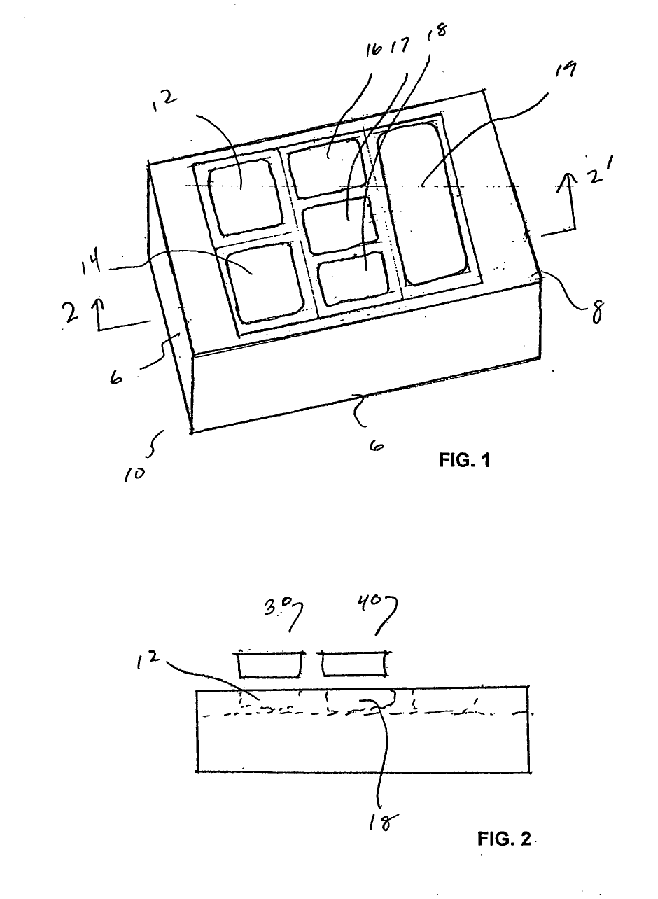

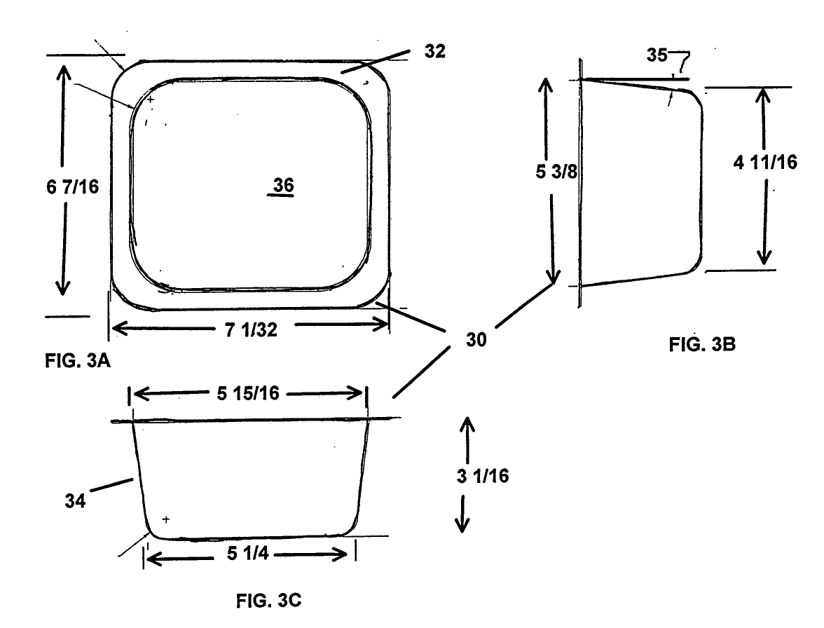

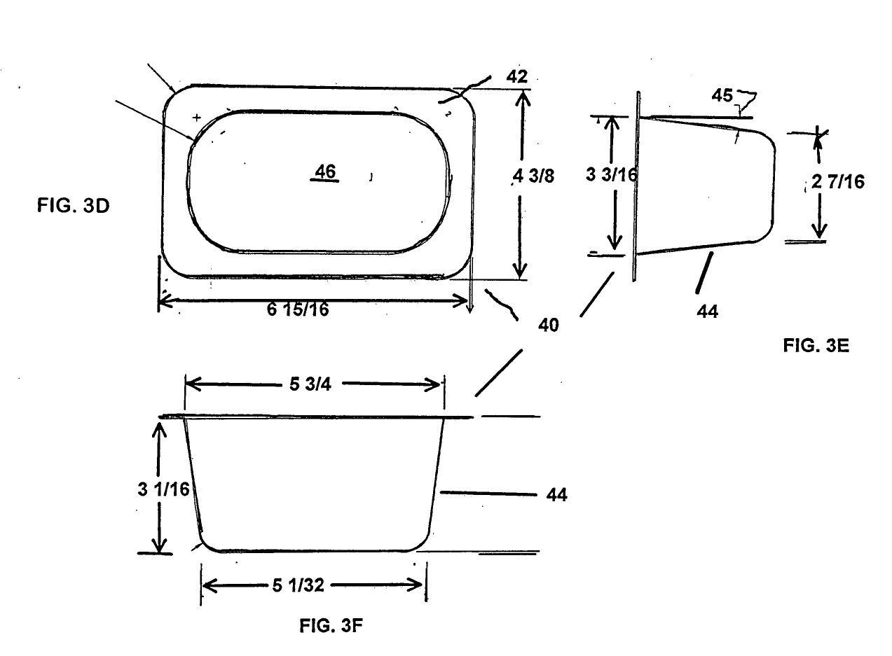

With reference to FIGS. 1 and 2, a serving unit 10 has sidewalls 6 and a top surface 8 with multiple openings for accommodating one third tray, two one sixth trays and three one ninth trays. The openings 12, 14 for hold one sixth size trays and the openings 16, 17, 18 hold one ninth size trays. A one sixth size tray 30 is shown above opening 12 and one ninth size tray 40 is shown above opening 16. Turning to FIGS. 3A-3F, the tray 30 has a rim 32 and a bowl 34. The rim 32 is larger than the opening 12 and the bowl is smaller than the opening 12 so that the rim will rest on a portion of the surface 8 when the tray 30 is placed in the unit 10. Likewise, the tray 40 has a rim 42 and a bowl 44 and its rim is larger than opening 16 and the bowl is smaller than 16 so that the rim supports the bowl inside opening 16.

The food service industry has standard size trays and trays 30, 40 are made to meet that standard. With reference to FIGS. 3A-3C the one sixth pan has a rim 32 with outside dimensions of 7 1/32 by 6 7/16 inches. The inside dimensions of the rim are 5 15/16 by 5⅜ inches. It is 3 1/16 inches deep and its base 36 is 5¼ by 4 11/16 inches. The one ninth pan is shown in FIGS. 3D-3F. The one ninth pan 40 has a rim 42 with outside dimensions of 6 15/16 inches by 4⅜ inches. The inside dimensions of the rim are 5¾ by 3 3/16 inches. It is 3 1/16 inches deep and its base 46 is 5 1/32 by 2 7/16 inches. For both pans, the angles 35, 45 are about seven degrees.

The trays 30, 40 are made by thermoforming. That is a process which uses heat and pressure and/or vacuum to form parts from an extruded (flat) sheet of plastic. In a typical automated process, plastic sheet material is drawn from large rolls, heated to its softening temperature, and then formed into the desired shape using an aluminum forming tool. It is then cut into individual trays, stacked, inspected, counted, boxed and shipped. It is possible to make thin gage parts formed from sheet thickness of 1 to 100 mils. The one sixth and one ninth trays were subjected to test to determine their capacity to hold food in a display and to resist crushing. Using trays made from amorphous polyethylene terephthalate (APT) material with a starting thickness of 30 mils, the one sixth tray held 15 pounds before collapsing its rim; the one ninth tray held 20 pounds. In a crush test, a plate was placed on top of the trays to determine how much weight each could bear. The one sixth tray collapsed at 30 pounds and the one ninth tray collapsed by 7 pounds. Other suitable materials include and are not limited to high density polyethylene (HDPE) and polypropylene (PP) with polyethylene (PE) coating.

The pans were also tested for their yield strength. In those tests, the pans were subjected to a force applied normal to a plate disposed across the top of the pan. The bottom of the pan also rested on a flat plate. The test determined peak force before the pan material yielded so that a smaller force was needed to continue displacement. The results are as follows:

| | | Peak Force | Deflection |
|---|---|---|---|
| Sample | Size | (lbs.) | (mils) |
| A | 1/6 | 31.7 | 50 |
| B | 1/6 | 30.9 | 41 |
| C | 1/9 | 7.8 | 47 |
| D | 1/9 | 6.0 | 47 |

Such materials are useful for making disposable trays. These materials have physical properties which make them ideal for holding condiments and prepared foods. They are lightweight, low cost, easily fabricated or thermoformed, tough, flexible and transparent. They become viscous when heated to high enough temperature, and becomes rigid again upon cooling. The heating-cooling cycle may be repeated indefinitely with no significant chemical change.

The materials have a number of advantages. They have a low cost per pound and that gives low cost per unit area. Their low cost is a key factor in making single use, disposable serving trays. Since the trays are a fraction of the cost of the condiments and prepared foods, there is an incentive for establishment operators to use the disposable trays rather than stainless steel and durable plastic trays. The light weight of the material adds little or nothing to shipping costs of packaged condiments and prepared foods. Many localities have existing manufacturers who have thermoforming, injection molding or blow molding equipment, so that sources of supply are readily available to operators. The materials used in the trays have more than adequate mechanical strength for holding food even when the trays are very thin. The materials are tough and resist tear and puncture even when very thin. They are useful over a wide range of temperatures, dimensionally stable, unaffected by changes of relative humidity, serviceable from −80° F., through 175° F., and have under 1% dimensional change when exposed for one month at 160° F. They are also chemically inert, non-corrosive to confined metal, unaffected by contacted food including meat fats. The materials are physically inert to watery substances and solutions of acids, alkalies, salts, soap detergents taste and odor free. They have no influence on contacted food and will not absorb meat fats and blood. The materials are supplied and shipped in roll form. After thermoforming to shapes the materials still comply with provisions of Food and Drug Administration Regulation Section 121,2510 (U.S.A.), “May be safely used as components of articles intended for use in contact with food” without limitation as to watery or fatty food. Mold or fungus growths are not supported because no nutrient is supplied.

APT or other materials is shaped to a service tray of standard size by either vacuum or pressure thermoforming. APT is safe for use in contact with food according to Food and Drug Administration regulation. Many foods commonly packaged with thermoformed APT contain some fat, for instance, meat, cookies, and doughnuts. Because fat has extraordinary powers of absorbing odorous, volatile substances, taste of fatty foods can be easily changed by exposure to or confinement in packaging materials. Even slight taste changes make food unpalatable, even though not harmful, to the consumer. Consequently, APT has the advantage of contributing no foreign odor or taste to the food contents of the package and that is of equal importance to safe use. Perishable fruits and vegetables of all types can be packaged in containers made of APT to prolong freshness, prevent unnecessary damage from squeezing, handling and general exposure. Other thermoform plastics may be substituted to make the disposable trays of the invention. Such other plastics include and are not limited to oriented polystyrene sheet (OPS), polystyrene, and high impact polystyrene (HIPS).

It is well known in the art that rigid plastic trays are manufactured from a thermoplastic sheet. The sheet is stripped from a pre-manufactured roll, reheated to a suitable forming temperature then indexed horizontally through a vacuum and or pressure forming station. After forming, the articles may be trimmed while still inside the form tool, or stripped as an integral part of the sheet then indexed through a shearing station where the articles are separated from the sheet. This type of process is commonly referred to as Flat Bed Thermoforming and is described in U.S. Pat. Nos. 3,470,281, 3,578,735 and 3,600,753, whose disclosures are herein incorporated by reference. The trays of the invention may also be made in accordance with the apparatus and processes shown and described in U.S. Pat. Nos. 4,388,356 and 5,795,535 whose disclosures are also incorporated by reference.

Thermoforming is one process for making disposable trays. Other processes include injection and blow molding. Both of those processes require more expensive molding machines and more expensive molds than are needed for thermoforming. On the other hand, injection molding and blow molding can produce products with uniform thicknesses. In contrast, thermoform products have thinner regions on portions of product that are farther from the initial sheet.

Depending upon the material selected, trays made of thermoformed plastics may be fashioned from sheet stock that has a starting thickness between 100 and 5 mils. In another range, the starting thickness may be between 75 and 10 mils. In a still further range, the starting thickness may vary between 50 and 10 mils.

The disposable trays of the invention have thick enough walls and bottoms to withstand a load placed on the tray. In its broader aspects the invention may use material that has a range of load tolerance between 160 and 1 pounds. In another range, the load tolerance is between 100 and one pound. In a still further range, the load tolerance is between 50 and one hundred pounds.

After the trays are formed, they may be filled with condiments or prepared foods. After the disposable trays are filled, they pass through a conventional lid machine where film lids are applied to the tops of the trays to seal the contents. The lid may be any suitable flexible or solid sealing material. There are many materials that use electrostatic attraction or adhesives to keep the lid secure on the tray. Then the trays with their contents may be shipped to food establishments.

The invention thus provides a new apparatus and method that uses disposable, one-time-useable thin wall thermoformed serving trays. The trays are so thin that their corners where their sidewalls meets their respective bases may be easily deflected or collapsed by using minimal pressure applied with a finger. The thin trays have essentially only one use and that is for holding condiments and prepared foods in a display unit. After their single use for that purpose, the trays are too flimsy to clean. A user simply discards the one-time used trays as trash or recycles them.

Having thus shown and described one or more embodiment of the invention, those skilled in the art will understand that changes, additions, deletions and substitutions may be made to the elements and limitations of the following claims without departing from their spirit and scope.

1. A method for replenishing condiments and prepared foods in a serving display unit comprising the steps of:
providing a serving display unit having one or more compartments for holding one or more serving trays;
providing one-time-useable serving trays;
filling the one-time-useable serving trays with condiments or prepared foods;
inserting the one-time-useable serving trays into the compartments in the serving display unit.

2. The method of claim 1 wherein the trays comprise a material that is rigid enough to maintain a rectangular shape when filled with condiments and thin enough to have corners that are flexible to the touch and is formed by one of the processed of the group consisting of thermoforming, injection molding and blow molding.

3. The method of claim 1 wherein the tray is formed from a thermoform film that has an initial thickness between 100 and 1 mils.

4. The method of claim 1 wherein the tray is formed from a thermoform film that has an initial thickness between 75 and 1 mils.

5. The method of claim 1 wherein the tray is formed from a thermoform film that has an initial thickness between 50 and 1 mils.

6. The method of claim 1 wherein the tray has a rectangular shaped bowl and a top rim with rounded corners and corners at the floor are thin enough to collapse when finger pressure is applied to their outside surface.

7. The method of claim 1 wherein the bowl has a thickness between 55 and 1 mils.

8. The method of claim 1 wherein the tray comprises a standard size tray that resists crushing of a force between 160 and 1 pounds.

9. The method of claim 1 wherein the tray comprises a standard size tray that resists crushing of a force between 100 and 1 pounds.

10. The method of claim 1 wherein the tray comprises a standard size tray that resists crushing of a force between 50 and 1 pounds.

11. The method of claim 1 wherein the tray comprises a one sixth tray that holds up to 15 pounds before collapsing its rim and supports at least 30 pounds before collapsing or a one ninth tray that holds up to 20 pounds before collapsing at its rim and support 7 pounds before collapsing.

12. An apparatus for providing and holding an array of disposable trays for holding condiments comprising:
a base having a surface with one or more openings, each opening for receiving one size of a number of standard size condiment trays;
one or more disposable condiment trays arranged in the openings in the base, each condiment tray characterized by
a rim for resting on the surface of the base to support the condiment tray in the opening,
a bowl integral with the rim and extending through the opening in the surface, wherein the rim and bowl comprise thermoformed film rigid enough to maintain a rectangular shape when filled with condiments thin enough to have corners that are flexible to the touch.

13. The apparatus of claim 12 wherein the trays comprise a material that is rigid enough to maintain a rectangular shape when filled with condiments and thin enough to have corners that are flexible to the touch.

14. The apparatus of claim 12 wherein the tray is formed from a thermoform film that has an initial thickness between 100 and 1 mils.

15. The apparatus of claim 12 wherein the tray is formed from a thermoform film that has an initial thickness between 75 and 1 mils.

16. The apparatus of claim 12 wherein the tray is formed from a thermoform film that has an initial thickness between 50 and 1 mils.

17. The apparatus of claim 12 wherein the tray has a rectangular shaped bowl and a top rim with rounded corners and corners at the floor are thin enough to collapse when finger pressure is applied to their outside surface.

18. The apparatus of claim 12 wherein the bowl has a thickness between 55 and 1 mils.

19. The apparatus of claim 12 wherein the tray comprises a standard size tray that resists crushing of a force between 160 and 1 pounds.

20. The apparatus of claims 12 wherein the tray comprises a standard size tray that resists crushing of a force between 100 and 1 pounds.

21. The apparatus of claim 12 wherein the tray comprises a standard size tray that resists crushing of a force between 50 and 1 pounds.

22. The apparatus of claim 12 wherein the tray is formed by thermoforming, injection molding or blow molding.

23. The apparatus of claim 12 wherein the tray comprises a one sixth tray that holds up to 15 pounds before collapsing its rim and supports at least 30 pounds before collapsing or a one ninth tray that holds up to 20 pounds before collapsing at its rim and support 7 pounds before collapsing.

24. A method for supplying and replenishing condiments and prepared foods in a serving display unit comprising the steps of:
providing a plurality of one-time-useable serving trays;
filling the one-time-useable serving trays with condiments or prepared foods;
attaching a film lid to the filled trays to protect their contents;
inserting the one-time-useable serving trays into compartments of the serving display unit; and
removing the lid from the trays to expose the contents for use by staff or customers.

25. The method of claim 24 wherein the trays comprise a material that is rigid enough to maintain a rectangular shape when filled with condiments and thin enough to have corners that are flexible to the touch.

26. The method of claim 24 wherein the tray is formed from a thermoform film that has an initial thickness between 100 and 1 mils.

27. The method of claim 24 wherein the tray is formed from a thermoform film that has an initial thickness between 75 and 1 mils.

28. The method of claim 24 wherein the tray is formed from a thermoform film that has an initial thickness between 50 and 1 mils.

29. The method of claim 24 wherein the tray has a rectangular shaped bowl and a top rim with rounded corners and corners at the floor are thin enough to collapse when finger pressure is applied to their outside surface.

30. The method of claim 24 wherein the bowl has a thickness between 55 and 1 mils.

31. The method of claim 24 wherein the tray comprises a standard size tray that resists crushing of a force between 160 and 1 pounds.

32. The method of claim 24 wherein the tray comprises a standard size tray that resists crushing of a force between 100 and 1 pounds.

33. The method of claim 24 wherein the tray comprises a standard size tray that resists crushing of a force between 50 and 1 pounds.

34. The method of claim 24 wherein the tray comprises a one sixth tray that holds up to 15 pounds before collapsing its rim and supports at least 30 pounds before collapsing or a one ninth tray that holds up to 20 pounds before collapsing at its rim and support 7 pounds before collapsing.
